(19) United States
(12) Patent Application Publication
(10) Pub. No.: US 2009/0034239 A1
(43) Pub. Date: Feb. 5, 2009

(54) PNEUMATIC TOOL HAVING A LIGHTING FIXTURE

(76) Inventor: Chin-Ho Hsu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/831,121

(22) Filed: Jul. 31, 2007

(51) Int. Cl. B25B 23/18

(52) U.S. Cl. 362/119

(57) ABSTRACT

A pneumatic tool having a lighting fixture includes a main body, a driving unit, a working unit and an illumination unit. A tool head is provided on the main body. The driving unit and the working unit are disposed in the main body. The working unit is driven by the driving unit. The main body further includes a holder integrally formed with the main body. The holder comprises a socket adapted to receive the illumination device therein. The illumination device includes a bulb holder, an illumination unit, an insulating ring, a battery and a switch. The switch includes a push button exposing outwardly from the socket for controlling lighting when the user is working at a dark place.

### BACKGROUND OF THE INVENTION

1. Field of the Invention

The present invention relates to a pneumatic tool having a lighting fixture, and more particularly to a main body provided with a holder to accommodate an illumination device for illumination purpose.

2. Description of the Prior Art

A conventional pneumatic tool uses air pressure to cause eccentric movement to drive a tool head to work. The tool head is located at the front of the pneumatic tool. The work would be difficult if the working area is at a dead spot or at a dark place.

### SUMMARY OF THE INVENTION

The present invention provides an illumination device to assist the lighting problem for pneumatic tools. According to the present invention, there is provided a pneumatic tool having a lighting fixture, comprising a main body, a tool head being provided on said main body; a driving unit disposed in said main body; a working unit disposed in said main body and driven by said driving unit; and characterized by: said main body further comprising a holder corresponding in position to said tool head, said holder comprising a socket to accommodate an illumination device, said illumination device comprising a bulb holder, an illumination unit, an insulating ring, a battery and a switch, said switch comprising a push button exposing outwardly from said socket to turn the illumination unit on or off.

Preferably, said holder is integrally formed with said main body.

Preferably, said socket comprises an upper threaded section and a lower threaded section, said bulb holder comprising a threaded section to engage with said lower threaded section of said socket, said switch comprising a threaded section to engage with said upper threaded section of said socket.

Preferably, said illumination unit is a light emitting diode or a bulb.

It is the primary object of the present invention to provide a pneumatic tool having a lighting fixture, which provides enough lighting.

It is another object of the present invention to provide a pneumatic tool having a lighting fixture, which is exchangeable and convenient.

### BRIEF DESCRIPTION OF THE DRAWINGS

FIG. 1 is an exploded view of a preferred embodiment of the present invention;

FIG. 2 is a perspective view of the preferred embodiment of the present invention;

FIG. 3 is a cross-sectional view of the preferred embodiment of the present invention; and

FIG. 4 is a cross-sectional view of the preferred embodiment of the present invention in use.

### DETAILED DESCRIPTION OF THE PREFERRED EMBODIMENT

A pneumatic tool having a lighting fixture of the present invention is to brighten the work space. The lighting fixture is adapted for a gun type, cutting type or vertical type of pneumatic tool.

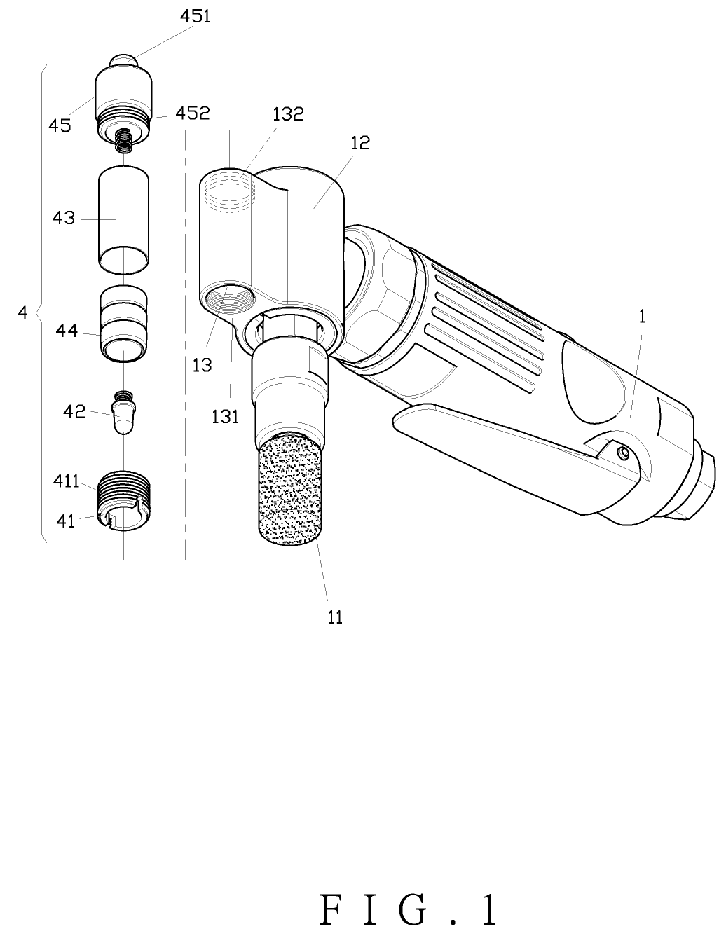

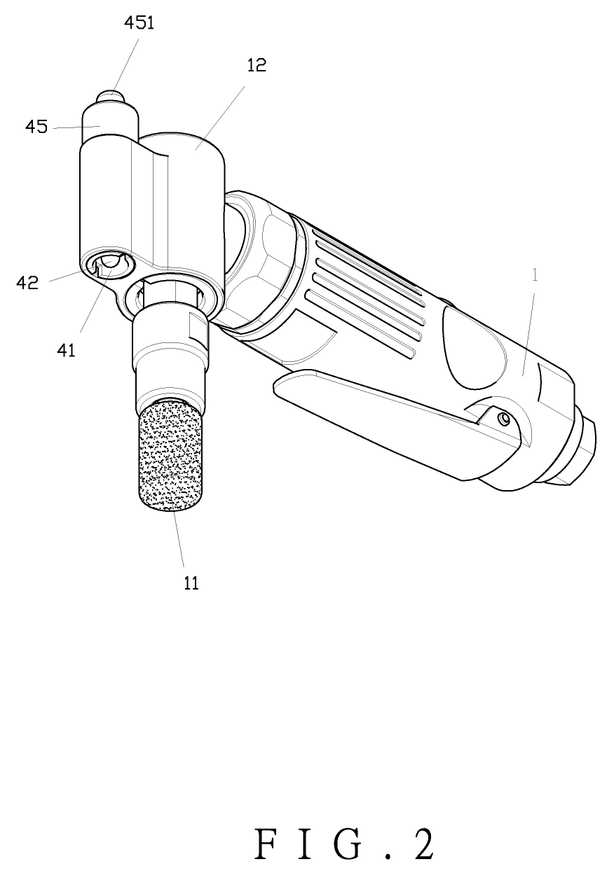

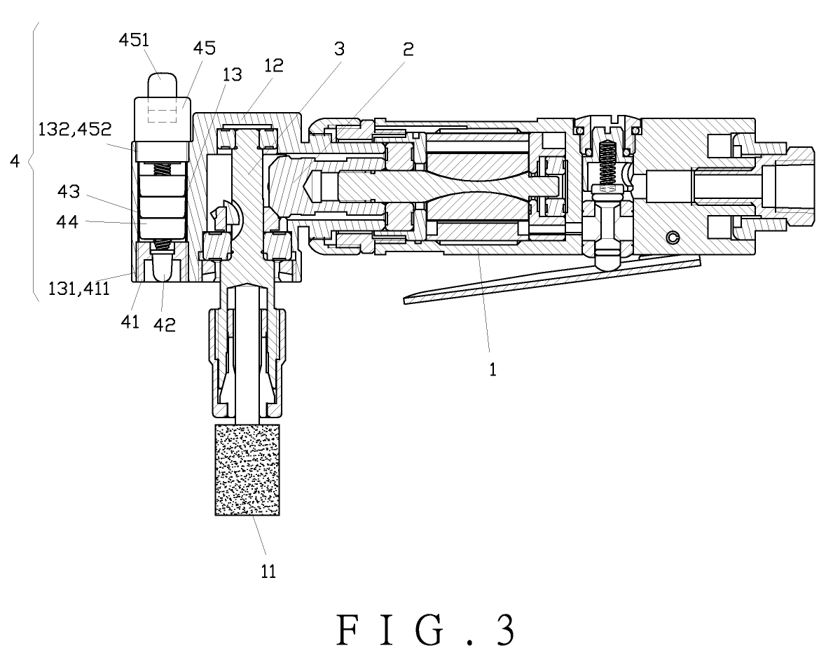

As shown in FIGS. 1, 2 and 3, a preferred embodiment of the present invention comprises a main body 1, a driving unit 2, a working unit 3 and an illumination device 4.

The main body 1 comprises a tool head 11 and a holder 12. The tool head 11 is disposed on the main body 1. The holder 12 corresponds in position to the tool head 11. The holder 12 comprises a socket 13 adapted to receive the illumination device 4. The socket 13 has an upper threaded section 131 and a lower threaded section 132.

The driving unit 2 is disposed in the main body 1.

The working unit 3 is disposed in the main body 1 and driven by the driving unit 2.

The illumination device 4 comprises a bulb holder 41, an illumination unit 42, an insulating ring 43, a battery 44 and a switch 45. The switch 45 comprises a push button 451 exposing outwardly from the socket 13 and a threaded section 452 to engage with the upper threaded section 132 of the socket 13. The bulb head 41 comprises a threaded section 411 to engage with the lower threaded section 131 of the socket 13.

The illumination unit 42 may be a light emitting diode or a bulb.

The insulating ring 43 is used to isolate the battery 44 from the main body 1.

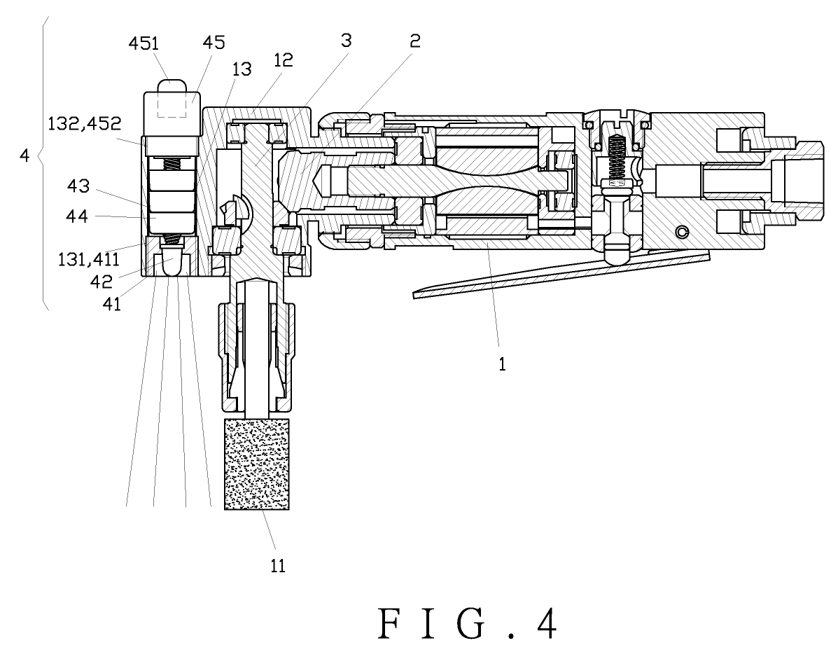

To operate the present invention, as shown in FIG. 4, the push button 451 of the switch 45 is pressed to turn the light on when the working place is dark so as to provide a bright working space.

What is claimed is:

1. A pneumatic tool having a lighting fixture, comprising:
a main body, a tool head being provided on said main body;
a driving unit disposed in said main body;
a working unit disposed in said main body and driven by said driving unit; and characterized by: said main body further comprising a holder corresponding in position to said tool head, said holder comprising a socket to accommodate an illumination device, said illumination device comprising a bulb holder, an illumination unit, an insulating ring, a battery and a switch, said switch comprising a push button exposing outwardly from said socket to turn the illumination unit on or off.

2. The pneumatic tool having a lighting fixture, as recited in claim 1, wherein said holder is integrally formed with said main body.

3. The pneumatic tool having a lighting fixture, as recited in claim 1, wherein said socket comprises an upper threaded section and a lower threaded section, said bulb holder comprising a threaded section to engage with said lower threaded section of said socket, said switch comprising a threaded section to engage with said upper threaded section of said socket.

4. The pneumatic tool having a lighting fixture, as recited in claim 1, wherein said illumination unit is a light emitting diode.

5. The pneumatic tool having a lighting fixture, as recited in claim 1, wherein said illumination unit is a bulb.
